(19) United States
(12) Patent Application Publication
(10) Pub. No.: US 2025/0298045 A1
(43) Pub. Date: Sep. 25, 2025

(54) SLIDE IMAGING APPARATUS

(71) Applicant: Roche Molecular Systems, Inc., Pleasanton, CA (US)

(72) Inventor: Denny Osswald, Biblis (DE)

(21) Appl. No.: 18/862,926

(22) PCT Filed: May 3, 2023
(86) PCT No.: PCT/EP2023/061640

§ 371 Date: Nov. 4, 2024

(30) Foreign Application Priority Data
May 4, 2022 (EP) 22171671.5

(51) Int. Cl. G01N 35/00

(52) U.S. Cl. CPC G01N 35/0099; G01N 35/00029; G01N 35/00584; G01N 2035/00039; G01N 2035/00138

(57) ABSTRACT

A method for autonomous teach-in of at least one target position of a supply device (120) of a slide imaging apparatus (110) is disclosed. The slide imaging apparatus (110) comprises at least one imaging device (126, 128) configured to generate an image of a sample mounted on a slide (140). The target position is a position on the imaging device (126, 128). The slide imaging apparatus (110) comprises at least one operating system (170) configured for controlling operation of the supply device (120). The method comprises the following steps
i) (186) providing at least six pre-defined positions by using the operating system (170);
ii) (188) driving the supply device (120) to the six pre-defined positions until colliding with the imaging device (126, 128) by using the operating system (170) and detecting collisions with the imaging device (126, 128);
iii) (190) evaluating the detected collisions by using the operating system (170), thereby determining the target position.

### TECHNICAL FIELD

The present disclosure relates to a method for autonomous teach-in of at least one target position of a supply device of a slide imaging apparatus and to a slide imaging apparatus. Herein, the slide imaging apparatus can preferably be used in digital pathology; however, further uses are feasible.

### BACKGROUND ART

A slide imaging apparatus comprises an imaging device which is configured to generate an image of a sample mounted on a slide. The image generated by a modern imaging device is, typically, a digital image, and such an image may, therefore, be referred to as a “digital slide”. Typically, the sample mounted on the slide is a biological specimen, such as a tissue sample. Typically, the slide is a glass slide. Typically, a slide imaging apparatus is used in digital pathology, which can be understood as an image-based information environment that enables management of information generated from a digital slide.

Where an imaging device is capable of generating an image which may cover a majority or a complete surface of a slide, e.g. by using a scanning process, the corresponding slide imaging apparatus may be referred to as a “whole slide imaging” apparatus. A slide imaging apparatus may use a 2D (two-dimensional) camera or a line scan detector to generate the image of a sample mounted on a slide. Examples of a slide imaging apparatus are, for example, described in EP 0 053 4247 B1, EP 0 245 089 A2, U.S. Pat. Nos. 6,118,582 A, 6,522,774 B1, 6,640,014 B1, 6,711,283 B1, 7,682,573 B1, WO 2013/017855, U.S. Pat. Nos. 8,712,116 B2 and 9,116,035 B2.

In general, an imaging device has a capacity of processing between 1 and 1,000 slides simultaneously. Typically, a distinction can be made between an imaging device having a low throughput, which relates to a simultaneous processing of less than 10 slides, and an imaging device having a high throughput, which refers to the simultaneous processing of more than 100 slides, wherein an imaging device configured to simultaneously process 10 to 100 slides could, thus, be denoted as an imaging device having a moderate throughput. In order to charge the imaging device with one or more slides, individual slides are, typically, inserted manually or automatically into a slide repository, particularly selected from a slide tray or a slide rack, which is, subsequently, introduced into the imaging device for generating the desired image of a sample mounted on a slide.

WO 2021/191411 describes a slide imaging apparatus and a method for imaging a plurality of slides. The slide imaging apparatus comprises: —at least one first imaging device and at least one second imaging device, each configured to generate an image of a sample mounted on a slide; —a storage device loadable with a plurality of slides and configured to store the slides; and —a supply device configured to selectively supply the slides from the storage device to the at least one first imaging device or to the at least one second imaging device, wherein the at least one first imaging device and the at least one second imaging device comprise at least one visual indicator configured to indicate an operational status of the at least one first imaging device and the at least one-second imaging device, wherein the slide imaging apparatus further comprises at least one vision sensor configured to detect an operational status of the at least one first imaging device and of the at least one second imaging device using the at least one visual indicator.

WO 2021/191410 describes a slide imaging apparatus and a method for imaging a plurality of slides. The slide imaging apparatus comprises: —at least one imaging device configured to generate an image of a sample mounted on a slide, wherein the imaging device comprises at least one operating button; —a storage device loadable with a plurality of slides and configured to store the slides; and —a supply device configured to supply the slides from the storage device to the imaging device, wherein the supply device is configured to press the operating button. The slide imaging apparatus and the method for imaging a plurality of slides enable improved processing of the slides to be processed in an imaging device, wherein the slides are provided to be introduced into a slide reception of an imaging device. US 2002/068992 A1 describes a robot calibration system for calibration of a workpiece handling robot relative to a station. US 2009/302795A1 describes a robot teach tool for automatic teaching of pick and place positions for a robot. U.S. Pat. No. 6,323,616 B1 describes a wafer handling apparatus having input and output robotic systems directed by a programmed controller. US 2019/301980 A1 describes systems and methods for transport and processing of sectioned biological samples, in particular for use of a plurality of imaging and processing modalities to characterize sectioned tissue samples.

Automatic supply of slides within a slide imaging apparatus, e.g., from a storage device to an imaging device, can be performed by a supply device. Such supply device may comprise a robot or a robotic arm.

For programming a robot usually positions are taught in by human. In case the position(s) of the system change, the robot has to taught in again with adapted positions by human. This procedure, however, is complex and difficult.

### Problem to be Solved

It is, therefore, desirable to provide a slide imaging apparatus and a method for autonomous teach-in of at least one target position of a supply device of a slide imaging apparatus enabling an autonomous teach-in of the target position of the supply device.

### SUMMARY

This problem is addressed by a method for autonomous teach-in of at least one target position of a supply device of a slide imaging apparatus and a slide imaging apparatus with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a method for autonomous teach-in of at least one target position of a supply device of a slide imaging apparatus is disclosed. The slide imaging apparatus comprises at least one imaging device configured to generate an image of a sample mounted on a slide. The target position is a position on the imaging device. The slide imaging apparatus comprises at least one operating system configured for controlling operation of the supply device.

The term “sample” as used herein is a broad term and is to be given its ordinary and customary meaning to a person of ordinary skill in the art and is not to be limited to a special or customized meaning. The term may, specifically, refer, without limitation, to a biological specimen, such as a tissue or a smear. However, other kinds of samples may also be feasible.

The term “slide” as used herein is a broad term and is to be given its ordinary and customary meaning to a person of ordinary skill in the art and is not to be limited to a special or customized meaning. The term may, specifically, refer, without limitation, to a substrate which is designated for a sample to be mounted on a surface of the slide. The substrate may be mechanically stable. The substrate can comprise any material which provides sufficient mechanical stability. The substrate may be configured for carrying the sample without any changes during the processing to the slide. The substrate may exhibit a surface which is configured to be compatible with biological material. By way of example, the slide is a glass slide. Glass is known, on one hand, to provide sufficient mechanical stability and, on the other hand, to have a high compatibility with biological material. However, further kinds of materials for the slides may also be feasible.

The slide may have a form which may enable imaging of the sample mounted on the slide. The slide may be a plate having a 2D extension and a thickness. The 2D extension of the plate may exhibit a rectangular or circular form. The thickness of the plate may be small compared to a size of the extension, for example 20%, or 10%, or 5%, or less than a measure for a linear extent of the 2D extension of the plate. Such a design may allow and/or support generating a desired image of the sample.

The terms “imaging” or “generate an image” as used herein are broad terms and are to be given their ordinary and customary meaning to a person of ordinary skill in the art and are not to be limited to a special or customized meaning. The terms may, specifically, refer, without limitation, to providing a 2D two-dimensional representation of at least one property of the sample, also denoted by the term “image”, which can typically, be processed and displayed on a screen for being regarded by eyes of a viewer, e.g., without any further aids, apart from eyeglasses of the viewer. For this purpose the imaging device may be used.

The term “slide imaging apparatus” as used herein is a broad term and is to be given its ordinary and customary meaning to a person of ordinary skill in the art and is not to be limited to a special or customized meaning. The term may, specifically, refer, without limitation, to an arbitrary device configured for imaging the sample mounted on the slide. Further, the terms “apparatus” and “slide imaging apparatus” as used herein are broad terms and are to be given their ordinary and customary meaning to a person of ordinary skill in the art and are not to be limited to a special or customized meaning. The terms may, specifically, refer, without limitation, to a device having a plurality of components, e.g. as disclosed below in more detail.

The term “imaging device” as used herein is a broad term and is to be given its ordinary and customary meaning to a person of ordinary skill in the art and is not to be limited to a special or customized meaning. The term may, specifically, refer, without limitation, to a device which is configured for generating a 2D representation of at least one visual property of the sample. For example, the imaging device may be one or more of a 2D camera or a line scan detector. However, further kinds of imaging devices may also be feasible.

The slide imaging apparatus may comprise at least one first imaging device and at least one second imaging device each configured to generate an image of a sample mounted on a slide. The slide imaging apparatus may comprise one, two, three, four, five, six, or even more individual imaging devices. The supply device may be configured for selectively supplying the slides to the first imaging device or to the second imaging device. The individual imaging device can be individually addressed by the supply device.

The slide imaging apparatus may comprise a modular arrangement. The slide imaging apparatus may comprise a frame, e.g. a frame having wheels, and at least one plate connected to the frame, wherein one or more imaging devices may be arranged on the at least one plate. Herein, the at least one plate may be extendable from the frame independently from another plate, thus, improving access to each imaging device for service personnel. However, the plates may be dispensable in an embodiment in which the at last one imaging device may be considered as too delicate to be moved. The two or more imaging devices may be arranged in an adjacent manner with respect to each other, especially, one above the other in a vertical fashion or, as an alternative, next to each other in a horizontal fashion. In general, an adjacent arrangement of the at least two imaging devices may facilitate reaching the second imaging devices by the robotic arm of the supply device. Further, the slide imaging apparatus may comprise a table, wherein at least the storage device and the supply device can be mounted to the table. The slide imaging apparatus may comprise a housing at least partially encompassing the supply device, wherein the housing can comprise a safety door and a safety switch configured to detect a state of the safety door. Further, the slide imaging apparatus can comprise an emergency stop switch and, in addition, an emergency stop button, wherein the emergency stop switch can be operable using the emergency stop button. For additional details concerning further preferred arrangements of the slide imaging apparatus, reference can be made to WO 2021/191411 and WO 2021/191410, the disclosure of which is included herein by reference.

The slide imaging apparatus may comprise at least one monitor which is configured to show at least one image, e.g. a plurality of images, in a presentation which can be viewed by a user of the slide imaging apparatus. For example, the monitor can be mounted to a pivotable holder in order to facilitate viewing of the at least one image by a user from various positions.

The term “supply device” as used herein is a broad term and is to be given its ordinary and customary meaning to a person of ordinary skill in the art and is not to be limited to a special or customized meaning. The term may, specifically, refer, without limitation, to a device which is configured to transfer the slides, e.g. from a storage device, to the imaging device.

The supply device may comprise at least one robotic arm. The term “robotic arm” as used herein is a broad term and is to be given its ordinary and customary meaning to a person of ordinary skill in the art and is not to be limited to a special or customized meaning. The term may, specifically, refer, without limitation, to a programmable mechanical unit having a form of at least one of a hand or an arm and configured to move in a similar manner as the hand or the arm, using an electrical and/or pneumatic drive, including but not limited to gripping at least one object, in particular a slide or a slide holder, and transferring it to a defined destination.

The supply device may comprise a protrusion. The term “protrusion” as used herein is a broad term and is to be given its ordinary and customary meaning to a person of ordinary skill in the art and is not to be limited to a special or customized meaning. The term specifically may refer, without limitation, to an element of the supply device which protrudes over the other element of the supply device. For example, the protrusion is lance-shaped or finger-shaped. However, further kinds of shapes may also be feasible. The protrusion may be arranged at the robotic arm, e.g. at an end of the robotic arm. The protrusion may be arranged at the robotic arm by mounting the protrusion to the robotic arm or by forming the protrusion at the robotic arm.

The robotic arm may comprise a gripping device. The term “gripping device” as used herein is a broad term and is to be given its ordinary and customary meaning to a person of ordinary skill in the art and is not to be limited to a special or customized meaning. The term may, specifically, refer, without limitation, to a mechanical element which is, typically, designed for seizing an object, transferring it to a desired location and to release the object at the desired location. The specific gripping device may be configured to grip a slide or a slide holder, to transfer it to a slide reception of the imaging device in a tight fashion, thereby avoiding an instability or a loss of the slide during transport, and to release it, preferably to a slide tray as described elsewhere herein. Herein, the protrusion may be arranged at the gripping device, thus enabling the gripping device to insert the slide into a slide reception of the imaging device and to, concurrently, press the operating button, e.g. an eject button, of the imaging device, resulting in an ejection of a slide tray configured to hold the slide during the scanning of the slide in the imaging device. The gripping device may comprise a first gripping part and a second gripping part. The first gripping part and the second gripping part may be moveable relative to one another, e.g. in a linear fashion. The first gripping part and the second gripping part may have surfaces facing one another. The surfaces may be substantially plane, thus, supporting the tight grip. However, further kinds of arrangements of the protrusion may, still, be conceivable.

The supply device may be configured for pressing an operating button by using the protrusion. The operating button may be impinged by the protrusion at various events, which may result in an abrasion of at least one of the protrusion or the operating button. The supply device may comprise a protective cover configured to cover the protrusion. The term “protective cover” as used herein is a broad term and is to be given its ordinary and customary meaning to a person of ordinary skill in the art and is not to be limited to a special or customized meaning. The term may, specifically, refer, without limitation, to a preferably flexible object which can be arranged to separate the component to be covered from surrounding objects. Herein, a shape of the protective cover may be formed to cover the lance-shaped or finger-shaped protrusion in a particularly tight fashion. As a result, the protective cover may, thus, be configured to protect at least one of the protrusion and/or the operating button from abrasion.

The slide imaging apparatus may comprise at least one storage device loadable with a plurality of slides and configured for storing the slides. The storage device may be loadable with slide holders. The slide holders may be configured for holding a plurality of slides. The supply device may be configured for conveying the slides from the imaging device to the storage device. The supply device may be configured for supplying the slides from the storage device to the imaging device. The term “storage device” as used herein is a broad term and is to be given its ordinary and customary meaning to a person of ordinary skill in the art and is not to be limited to a special or customized meaning. The term may, specifically, refer, without limitation, to a slide repository which is designated for receiving an individual slide holder or, alternatively, more than one slide holder simultaneously, wherein each slide holder is configured to hold more than one slide. For example, the storage device may comprise at least two compartments, wherein each of the compartments is configured to store a portion of the slides. Herein, the compartments may comprise at least two rows which are placed in an adjacent manner, thus, storing the slides next to one another. The storage device may be selected from a slide tray or a slide rack, however, further types of storage devices may also be feasible. However, further kinds of arrangements of the slides and/or the slide holders, respectively, in the storage device may also be feasible. Thus, the storage device may be loadable with the plurality of slides, e.g. in a manual fashion, wherein, however, an automatic loading of the storage device may also be conceivable.

The slide imaging apparatus may be configured for subsequently introducing the slides into the imaging device for generating the desired image of a sample mounted on the slide. In the slide imaging apparatus, the plurality of the slides may be loaded into the storage device, where the slides are stored until they are supplied from the storage device to the imaging device. The supplying of the slides from the storage device to the at least one imaging device may be performed by using the supply device in an automated fashion.

The terms “in an automated fashion” and “automatedly” as used herein are broad terms and are to be given its ordinary and customary meaning to a person of ordinary skill in the art and are not to be limited to a special or customized meaning. The terms may, specifically, refer, without limitation, to a kind of process which is performed without direct interaction of a user of the slide imaging apparatus on a basis of an algorithm. For example, the transfer of the slides may be performed without manual performance of the user.

The supply device may be further configured to convey the slides after completion of a scanning process, back from the at least one imaging device to the storage device, e.g. to an associated position within the storage device into which the slides have been loaded. In other words, the supply device may be configured to convey the slides back from the imaging device to the same position within the storage device into which the slides had been loaded before they were transferred from the storage device to the imaging device. Thus, a user of the slide imaging apparatus can receive back the slides in the same order in which they had been provided to the storage device, thus facilitating a subsequent identification and possible further processing of the slides.

As outlined above, the imaging device comprises an operating button. The term “operating button” as used herein is a broad term and is to be given its ordinary and customary meaning to a person of ordinary skill in the art and is not to be limited to a special or customized meaning. The term may, specifically, refer, without limitation, to a component of a device which is, typically, located on a surface of the corresponding device being accessible to a person or to an object and which can be pressed or released, whereby a piece of information is transmitted to the device, whereinafter the device may execute an operation. Hereby, the terms “press”, “pressed” or “pressing” may, specifically, may refer, without limitation, to impinging the button by a person or by an object, whereas the terms “release”, “released” or “releasing” may, specifically, may refer, without limitation, to removing a pressure from the button, each in a fashion that a position of the button relative to the surface of the device may be subject to a change which may exceed a predefined threshold.

The operating button may be or comprise an eject button. The term “eject button” as used herein is a broad term and is to be given its ordinary and customary meaning to a person of ordinary skill in the art and is not to be limited to a special or customized meaning. The term may, specifically, refer, without limitation, to a particular kind of button which may be designed to provide an object, specifically a component of the device, to a user or an object pressing the button. With particular regard to the present disclosure, the eject button is configured to eject a slide tray when the eject button is pressed. The term “slide tray” as used herein is a broad term and is to be given its ordinary and customary meaning to a person of ordinary skill in the art and is not to be limited to a special or customized meaning. The term may, specifically, refer, without limitation, to an element configured to hold at least one slide or a slide holder, e.g. during the scanning of the slide in the imaging device.

As outlined above, the slide imaging apparatus comprise an operating system. The operating system may be configured for controlling operation of at least one component of the slide imaging apparatus that may e.g. be selected from at least one of the supply device and the at least one imaging device.

The operating system may comprise at least one processing device. The term “processing device” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. The processing device may be configured for processing basic instructions that drive the computer or system. As an example, the processing device may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. The processing device may be a multicore processor. Specifically, the processing device may be or may comprise a central processing unit (CPU). Additionally or alternatively, the processing device may be or may comprise a microprocessor, thus specifically the processing device's elements may be contained in one single integrated circuitry (IC) chip. Additionally or alternatively, the processing device may be or may comprise one or more application specific-integrated circuits (ASICs) and/or one or more field-programmable gate arrays (FPGAs) or the like.

The operating system may comprise at least one communication interface. The term “communication interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may be at least one web interface.

The operating system may comprise at least one human-machine-interface. The term “human-machine-interface” as used herein is a broad term and is to be given its ordinary and customary meaning to a person of ordinary skill in the art and is not to be limited to a special or customized meaning. The term specifically may refer, without limitation, to an interface configured for human machine interaction, e.g. as a keyboard, a display device, a screen, a touch screen, gesture and/or speech recognition, and the like. For example, the human-machine-interface may comprise a keyboard and a display device, e.g. the monitor described above or a further display device. For example, the display may be configured to present at least one item of information related to an operational status of the slide imaging apparatus to the user.

A position of the elements of the slide imaging apparatus may be one or more of variable, adaptable and adjustable within the frame. For example, the plate of the at least one imaging device and/or the plates of the imaging devices may be adjustable in height. In this case, the position, e.g. translation and/or orientation, of the one or more imaging devices may change and with it the position of an operating button and further elements of the imaging device. Additionally or alternatively, the position of the slide reception of the imaging device may be one or more of variable, adaptable and adjustable. However, knowledge about one or more of these positions, also denoted as target positions, may be essential for the supply device for proper supply and/or introducing and/or removing the slides from the imaging device. The term “target position” as used herein is a broad term and is to be given its ordinary and customary meaning to a person of ordinary skill in the art and is not to be limited to a special or customized meaning. The term specifically may refer, without limitation, to a position of the imaging device and/or of an element of the imaging device. The target position may be a position which is used for operating the supply device. The target position may be a position to which the supply device is driven for performing a pre-defined action, e.g. one or more of gripping at least one slide, pressing a button, releasing at least one slide and the like. The target position may be a position of at least one operating button of the imaging device and/or of at least one slide reception of the imaging device. The relative positions of the elements of the imaging device, e.g. of the operating button and/or the slide reception, with respect to the imaging device may be pre-known. For example, the relative positions may be stored in the database of the operating system. Thus, in case the position of the imaging device in space, i.e. translation and orientation, is known, the position of the elements of the imaging device are known, too.

Usually, for programming of the supply device, the target position may be taught in to the supply device by human. However, in case of the changes to the system, the teach-in procedure has to be repeated which is complex, time consuming and difficult. The present invention therefore proposes an autonomous teach-in of at least one target position.

The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps
i) providing at least six pre-defined positions by using the operating system;
ii) driving the supply device to the six pre-defined positions until colliding with the imaging device by using the operating system and detecting collisions with the imaging device;
iii) evaluating the detected collisions by using the operating system, thereby determining the target position.

The term “teach-in” as used herein is a broad term and is to be given its ordinary and customary meaning to a person of ordinary skill in the art and is not to be limited to a special or customized meaning. The term specifically may refer, without limitation, to a procedure for programming a robot. The term “autonomous teach-in” as used herein is a broad term and is to be given its ordinary and customary meaning to a person of ordinary skill in the art and is not to be limited to a special or customized meaning. The term specifically may refer, without limitation, to the fact that the teach-in of the robot is performed without manual or human interaction with the robot during the teach-in. For this purpose, at least six pre-defined positions may be provided to the operating system to which the supply device is driven until colliding with the imaging device. The coordinates, e.g. points, reached in this way may be stored by the operating system, e.g. in at least one database of the operating system. A program sequence for driving the supply device to the six pre-defined positions may comprise the supply device autonomously moving to all the pre-defined positions.

The term “providing” as used herein is a broad term and is to be given its ordinary and customary meaning to a person of ordinary skill in the art and is not to be limited to a special or customized meaning. The term specifically may refer, without limitation, to retrieving and/or selecting the pre-defined positions. The providing of the six pre-defined positions may comprises user input of the pre-defined positions via the human-machine-interface and/or receiving the six pre-defined positions from a database, e.g. of the operating system and/or of an external database such as of a further computer or cloud. Additionally, further parameters may be entered by the user and/or may be retrieved from the database, e.g. for movement between the individual positions such as velocity and/or acceleration and/or accuracy. The pre-defined positions may be distributed, e.g. evenly, in space at an expected position of the imaging device. For example, the pre-defined positions may be distributed on at least one expected plane of at least one side of the imaging device at which the target position is located. In case of a plurality of imaging device more than 6 pre-defined positions may be used, e.g. 6 pre-defined positions per imaging device.

The driving of the supply device to each of the six pre-defined positions may comprise moving the robotic arm from an initial position along a path. The path may be pre-defined, e.g. pre-programmed. The operating system may drive the supply device as long on the path until a collision with the imaging device is detected. In step ii) the supply device may be successively driven respectively along a path from an initial position to the six pre-defined positions until colliding with the imaging device. The supply device is driven along the respective path until a collision with the imaging device is detected, also beyond the respective pre-defined position. The operating system may be configured for limiting the driving of the supply device along a path, e.g. considering a time limit. In case no collision is detected within a predefined time limit of driving along the path, the driving may be aborted and/or continued in a different direction. For example, in case no collision is detected within a predefined time limit an indication, e.g. a message and/or a request for user action, may be issued by the operating system via the human-machine-interface.

The driving of the supply device in step ii) may be performed by driving from point-to-point (P2P) and/or by using a continuous path (CP). In case of P2P, the supply device may be driven from position n to position n+1. The path between the points may be preprogrammed or may be calculated online, i.e. during teach-in, considering the detected points of collision. In case of CP, the supply device may consider a predefined path between the six pre-defined positions.

In step ii), the supply device may be driven with a velocity such that collisions with the imaging device are deformation-free for the supply device and the imaging device.

The term “collision” as used herein is a broad term and is to be given its ordinary and customary meaning to a person of ordinary skill in the art and is not to be limited to a special or customized meaning. The term specifically may refer, without limitation, to an interaction between the imaging device and the supply device, e.g. a contact and/or crash.

The detecting of the collisions with the imaging device may be performed by using at least one collision sensor. The collision sensor may comprise one or more of at least one optical sensor, at least one tactile sensor. The tactile sensor may be a mechanical tactile sensor and/or an inductive tactile sensor and/or a capacitive tactile sensor. The collision sensor may be an element of the supply device, e.g. of the protrusion. Additionally or alternatively, the sensor may be an external sensor e.g. an imaging sensor of the slide imaging apparatus. The slide imaging apparatus may comprise at least one wirebound and/or wireless connection between the sensor and the operating system for exchanging data, e.g. sensor data for evaluation by the operating system, and/or commands, e.g. for controlling the sensor. The point in space at which the collision is detected may be denoted as collision location.

Step iii) may comprises determining coordinates for each collision location i, e.g. 3D coordinates, with i from 1 to n, with n being the number of pre-defined positions. The evaluation of the detected collisions may comprise solving a linear equation system considering the coordinates of the determined collision locations thereby determining the target position. The target position may be defined by a six dimensional pose comprising translation in three perpendicular axes x, y, z and three orientation values rot (x), rot (y), rot (z), denoted below as rotx, roty, rotz. For example, the positions of the 6 collision locations may be (X1′, X2′, Y1′, Y2′, Z1′, Z2′) with each having six values, wherein X1′, Y1′, Z1′, X2′, Y2′, Z2′ define the initial position and X1, Y1, Z1, X2, Y2, Z2 define the detected collision location. The equation system may be defined as

$$x = ( X 1 \cdot x - X 2 \cdot x ) / 2 + X 2 \cdot x$$

$$y = ( Y 1 \cdot y - Y 2 \cdot y ) / 2 + Y 2 \cdot y$$

$$z = ( Z 1 \cdot z - Z 2 \cdot z ) / 2 + Z 2 \cdot z$$

$$rotx = a {tan}^{2} ( ( Y 2 \cdot y - Y 1 \cdot y ) , ( Y 2 \cdot x - Y 1 \cdot x ) )$$

$$roty = 0$$

$$rotz = a {tan}^{2} ( ( Z 2 \cdot z - Z 1 \cdot z ) , ( Z 2 \cdot x - Z 1 \cdot x ) )$$

Step iii) may further comprise at least one coordinate transformation into Euler orientations. For example, the operating system may use for controlling the supply device Euler orientations q1, q2, q3, q4. For example, the following transformation may be performed:

x1_ := cos(rotz) * cos(roty);
x2_ := sin(rotz) * cos(roty);
x3_ := −sin(roty);
y1_ := cos(rotz) * sin(roty) * sin(rotx) − sin(rotz) * cos(rotx);
y2_ := sin(rotz) * sin(roty) * sin(rotx) + cos(rotz) * cos(rotx);
y3_ := cos(roty) * sin(rotx);
z1_ := cos(rotz) * sin(roty) * cos(rotx) + sin(rotz) * sin(rotx);
z2_ := sin(rotz) * sin(roty) * cos(rotx) − cos(rotz) * sin(rotx);
z3_ = cos(roty) * cos(rotx);
x1 := −z1_;
x2 := −z2_;
x3 := −z3_;
y1 := x1_;
y2 := x2_;
y3 := x3_;
z1 := −y1_;
z2 := −y2_;
z3 := −y3_;
IF y3−z2 >= 0 THEN
sigQ2 := 1;
ELSE
sigQ2 := −1;
ENDIF
IF z1−x3 >= 0 THEN
sigQ3 := 1;
ELSE
sigQ3 := −1;
ENDIF
IF x2−y1 >= 0 THEN
sigQ4 := 1;
ELSE
sigQ4 := −1;
ENDIF
q1 := sqrt(x1+y2+z3+1) / 2;
q2 := sigQ2 * sqrt(x1−y2−z3+1) / 2;
q3 := sigQ3 * sqrt(y2−x1−z3+1) / 2;
q4 := sigQ4 * sqrt(z3−x1−y2+1) / 2;

After performing step iii), the operating system may have knowledge about the target position with its degrees of freedom. The method may allow that the teach-in can be performed autonomously, in particular completely autonomously. Therefore, adjusting of the positions of the imaging device and implementing changes can be performed faster and with reduced complexity. For example, in case of a slide imaging apparatus having two imaging devices at two different positions, during commissioning and/or after a service operation the position of one or both of the imaging devices relative to the supply device may change. The operating system may perform the method as described above and can autonomously calculate the target position for the operating button and/or the slide reception and teach-in the supply device.

The method may be computer-implemented. The term “computer-implemented” as used herein is a broad term and is to be given its ordinary and customary meaning to a person of ordinary skill in the art and is not to be limited to a special or customized meaning. The term specifically may refer, without limitation, to a process which is fully or partially implemented by using a data processing means, such as data processing means comprising at least one processing device. The term “computer”, thus, may generally refer to a device or to a combination or network of devices having at least one data processing means such as at least one processing unit. The computer, additionally, may comprise one or more further components, such as at least one of a data storage device, an electronic interface or a human-machine interface.

In a further aspect of the present invention, a slide imaging apparatus is disclosed. The slide imaging apparatus comprises
at least one imaging device configured to generate an image of a sample mounted on a slide, wherein the imaging device comprises at least one operating button, wherein the imaging device comprises at least one slide reception configured for receiving the slide for generating the image;
at least one supply device configured to supply slides to the slide reception of the imaging device, wherein the supply device is configured to press the operating button;
at least one operating system configured for controlling operation of the supply device, wherein the operating system is configured for
   driving the supply device to at least six pre-defined positions until colliding with the imaging device and detecting collisions with the imaging device;
   evaluating the detected collisions by using the operating system, thereby determining the position of the operating button and/or the slide reception.

The slide imaging apparatus may be configured for performing the method according to the present invention as described above or as described in more detail below. Thus, for possible definitions, options or embodiments, reference may be made to the description given above or as given in more detail below.

Further disclosed and proposed herein is a computer program including computer-executable instructions for performing the method according to the present invention in one or more of the embodiments enclosed herein when the instructions are executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps i) to iii) as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a non-transient computer-readable medium including instructions that, when executed by one or more processors, cause the one or more processors to perform the method according to the present invention. The non-transient computer-readable medium may be configured for controlling the operating system.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

Summarizing and without excluding further possible embodiments, the following embodiments may be envisaged:
Embodiment 1. A method for autonomous teach-in of at least one target position of a supply device of a slide imaging apparatus, wherein the slide imaging apparatus comprises at least one imaging device configured to generate an image of a sample mounted on a slide, wherein the target position is a position on the imaging device, wherein the slide imaging apparatus comprises at least one operating system configured for controlling operation of the supply device, wherein the method comprises the following steps
i) providing at least six pre-defined positions by using the operating system;
ii) driving the supply device to the six pre-defined positions until colliding with the imaging device by using the operating system and detecting collisions with the imaging device;
iii) evaluating the detected collisions by using the operating system, thereby determining the target position.

Embodiment 2. The method according to the preceding embodiment, wherein the target position is a position of at least one operating button of the imaging device and/or of at least one slide reception of the imaging device.

Embodiment 3. The method according to any one of the preceding embodiments, wherein the providing of the six pre-defined positions comprises user input of the pre-defined positions via at least one human-machine-interface and/or receiving the six pre-defined positions from a database.

Embodiment 4. The method according to any one of the preceding embodiments, wherein the pre-defined positions are distributed on at least one expected plane of at least one side of the imaging device at which the target position is located.

Embodiment 5. The method according to any one of the preceding embodiments, wherein in step ii) the supply device is driven with a velocity such that collisions with the imaging device are deformation-free for the supply device and the imaging device.

Embodiment 6. The method according to any one of the preceding embodiments, wherein in step ii) the supply device is successively driven respectively along a path from an initial position to the six pre-defined positions until colliding with the imaging device, wherein the supply device is driven along the respective path until a collision with the imaging device is detected, also beyond the respective pre-defined position.

Embodiment 7. The method according to any one of the preceding embodiments, wherein the detecting of the collisions with the imaging device are performed by using at least one collision sensor, wherein the collision sensor comprises one or more of at least one optical sensor, at least one tactile sensor.

Embodiment 8. The method according to any one of the preceding embodiments, wherein step iii) comprises determining coordinates of a respective collision location, wherein the evaluation of the detected collisions comprises solving a linear equation system considering the coordinates of the determined collision locations thereby determining the target position.

Embodiment 9. The method according to any one of the preceding embodiments, wherein step iii) comprises at least one coordinate transformation into Euler orientations.

Embodiment 10. The method according to anyone of the preceding embodiments, wherein the method is computer-implemented.

Embodiment 11. A slide imaging apparatus comprising
at least one imaging device configured to generate an image of a sample mounted on a slide, wherein the imaging device comprises at least one operating button, wherein the imaging device comprises at least one slide reception configured for receiving the slide for generating the image;
at least one supply device configured to supply slides from to the slide reception of the imaging device, wherein the supply device is configured to press the operating button;
at least one operating system configured for controlling operation of the supply device, wherein the operating system is configured for
   driving the supply device to at least six pre-defined positions until colliding with the imaging device and detecting collisions with the imaging device;
   evaluating the detected collisions by using the operating system, thereby determining the position of the operating button and/or the slide reception.

Embodiment 12. The slide imaging apparatus according to the preceding embodiment, wherein the slide imaging apparatus is configured for performing the method according to any one of the preceding embodiments referring to a method.

Embodiment 13. The slide imaging apparatus according to any one of the preceding embodiments referring to a slide imaging apparatus, wherein the operating button is or comprises an eject button, wherein the imaging device is configured to eject a slide tray when the eject button is pressed.

Embodiment 14. The slide imaging apparatus according to any one of the preceding embodiments referring to a slide imaging apparatus, wherein the slide imaging apparatus comprises at least one first imaging device and at least one second imaging device each configured to generate an image of a sample mounted on a slide, wherein the supply device is configured for selectively supplying the slides to the first imaging device or to the second imaging device.

Embodiment 15. The slide imaging apparatus according to any one of the preceding embodiments referring to a slide imaging apparatus, wherein the supply device comprises at least one robotic arm.

Embodiment 16. The slide imaging apparatus according to the preceding embodiment, wherein the supply device comprises a protrusion configured for pressing the operating button, wherein the protrusion is lance-shaped or finger-shaped, wherein the protrusion is arranged at the robotic arm.

Embodiment 17. The slide imaging apparatus according to the preceding embodiment, wherein the slide imaging apparatus comprises a protective cover, wherein the protective cover is configured for protecting at least one of the protrusion and the operating button.

Embodiment 18. The slide imaging apparatus according to any one of the three preceding embodiments, wherein the robotic arm comprises a gripping device configured for gripping at least one of the slides or a slide holder configured to hold more than one slide.

Embodiment 19. The slide imaging apparatus according to the preceding embodiment, wherein the gripping device comprises a first gripping part and a second gripping part, wherein the first gripping part and the second gripping part are moveable relative to one another for gripping at least one of the slides or a slide holder configured to hold more than one slide.

Embodiment 20. The slide imaging apparatus according to any one of the preceding embodiments referring to a slide imaging apparatus, wherein the slide imaging apparatus comprises at least one storage device loadable with a plurality of slides and configured for storing the slides, wherein the supply device is configured for supplying the slides from the storage device to the imaging device.

Embodiment 21. The slide imaging apparatus according to the preceding embodiment, wherein the storage device is loadable with slide holders, wherein the slide holders are configured for holding a plurality of slides.

Embodiment 22. The slide imaging apparatus according to any one of the two preceding embodiments, wherein the supply device is configured for conveying the slides from the imaging device to the storage device.

Embodiment 23. A computer program comprising instructions which, when the program is executed by the slide imaging apparatus according to any one of the preceding embodiments referring to a slide imaging apparatus, cause the slide imaging apparatus to perform the method according to any one of the preceding embodiments referring to a method.

Embodiment 24. A computer-readable storage medium comprising instructions which, when the instructions are executed by the slide imaging apparatus according to any one of the preceding embodiments referring to a slide imaging apparatus, cause the slide imaging apparatus to perform the method according to any one of the preceding embodiments referring to a method.

Embodiment 25. A non-transient computer-readable medium including instructions that, when executed by one or more processors, cause the one or more processors to perform the method according to any one of the preceding embodiments referring to a method.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 schematically illustrates an embodiment of a slide imaging apparatus in a side view; and

FIG. 2 schematically illustrates an embodiment of a method for autonomous teach-in of at least one target position of a supply device of a slide imaging apparatus.

### DETAILED DESCRIPTION OF THE EMBODIMENTS

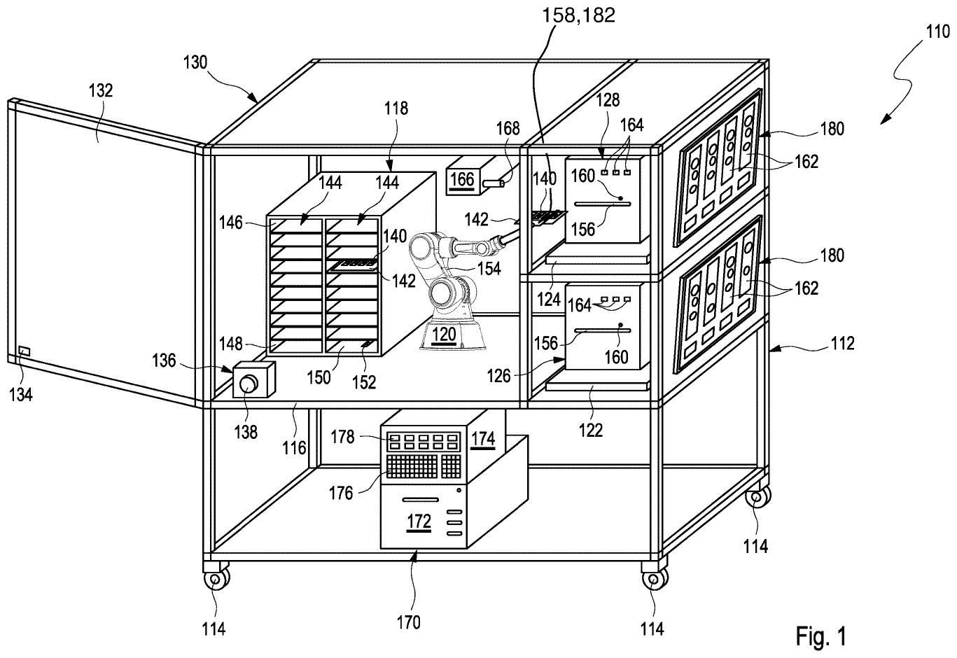

FIG. 1 schematically illustrates an embodiment of a slide imaging apparatus 110 according to the present disclosure in a side view. As shown in FIG. 1, the slide imaging apparatus 110 may comprise a frame 112. The frame 112 may comprise wheels 114, thus, enabling the slide imaging apparatus 110 to be moved to a desired location. As further depicted in FIG. 1, the frame 112 further comprises a table 116. At least a storage device 118 and a supply device 120 may be mounted to the table 116. However, further kinds of arrangements for the storage device 118 and for the supply device 120 may also be conceivable.

Further according to the embodiment as illustrated in FIG. 1, a first plate 122 and a second plate 124 are connected to the frame 112, wherein a first imaging device 126 is arranged on the first plate 122, while a second imaging device 128 is arranged on the second plate 124. Further embodiments of the slide imaging device 110 (not depicted here) comprising a single imaging device only or three, four, five, six, or more individual imaging devices may also be feasible, wherein the at least one imaging device 126, 128 can be individually addressed by the supply device 120 as disclosed above or below in more detail. As a result of the particular arrangement as shown in FIG. 1, the first imaging device 126 and the second imaging device 128 are arranged one above the other. However, further kinds of arrangements for the first imaging device 126 and for the second imaging device 128 may also be conceivable, in particular as long as they can be reached by the supply device 120. In addition, the first plate 122 and the second plate 124 may be extendable from the frame 112, especially by using telescopic rails (not depicted here), in an independent fashion, in particular for facilitating access in the event of a service case. In this embodiment, an exact positioning can be achieved by depressions in the plates 122, 124 which are designed for receiving a respective base of the imaging devices 126, 128, respectively. However, further kinds of arrangements may also be feasible.

As further depicted in FIG. 1, the slide imaging apparatus 110 may comprise a housing 130, which at least partially encompasses the supply device 120, thus, supporting an undisturbed operation of the supply device 120. As schematically illustrated in FIG. 1, the housing 130 has a safety door 132 and a safety switch 134, wherein the safety switch 134 is configured to detect a state of the safety door 132, such as open state or a closed state of the safety door 132. However, further kinds of safety provisions may also be possible.

Further, the embodiment of the slide imaging apparatus 110 as depicted in FIG. 1, comprises an emergency stop switch 136, wherein the emergency stop switch 136 is operable here using an emergency stop button 138. However, further kinds of emergency provisions may also be feasible. Upon pressing the emergency stop button 138, the emergency stop switch 136 can induce an immediate stop of the operation of the slide imaging apparatus 110 if considered to be required by service personnel.

As schematically illustrated in FIG. 1, the storage device 118 is loadable with a plurality of slides 140 and configured to store the slides 140. The plurality of slides 140 may be manually loaded to the storage device 118. For this purpose, the storage device 118 may be loadable with at least one of individual slides and slide holders 142, wherein each slide holder 142 is configured to hold more than one slide 140. As further depicted in FIG. 1, the storage device 118 is configured to store the slides 140 or the slide holders 142, respectively, in rows 144 which are located in adjacent fashion next to each another. However, further arrangements of the storage device 118 may also be conceivable.

In general, the supply device 120 may be configured to process the slides 140 or the slide holders 142, respectively, along a predetermined routine route, for example, starting on a top row 146 and continuing to a bottom row 148 of the storage device 118. In a particular embodiment as depicted here, the storage device 118 may comprise a fast lane 150, wherein the fast lane 150 may be configured to store at least one sample mounted to a designated slide 152, wherein each designated slide 152 as located in the fast lane 150 is determined for privileged processing outside the predetermined routine route as normally used by the supply device 120.

As further schematically illustrated in FIG. 1, the supply device 120 may be configured to selectively supply the slides 140 from the storage device 118 to the first imaging device 126 or to the second imaging device 128. The supply device 120 may be configured to automatedly supply the slides 140 from the storage device 120 selectively to the first imaging device 126 or to the second imaging device 128.

As schematically depicted there, the supply device 120 may comprise a robotic arm 154 which may, especially, be configured for introducing the slide 140 to a slide reception 156, in particular a slit, as comprised by each of the first imaging device 126 and the second imaging device 128, wherein the slide reception 156 is configured to receive the slide 140 for imaging purposes. The robotic arm 154 may comprise a gripping device 158 which is configured to grip the slide 140 or the holder 142, respectively. The gripping device 158 may have a protrusion (not depicted here), especially a lance-shaped or finger-shaped protrusion, which is configured to press an operating button 160 of the first imaging device 126 or of the second imaging device 128. However, a further kind of arrangement of the supply device 120 may, still, be possible.

In addition, the supply device 120 may be configured to convey the slides 140 back from the first imaging device 126 or from the second imaging device 128 after scanning to the storage device 118. Thereafter, the slides 140 can be removed in a manual fashion from the storage device 118, thus, providing space for further slides 140. The supply device 120 can be configured to convey the slides 140 back from the first imaging device 126 or from the second imaging device 128 to the storage device 118 to associated positions within the storage device 118 into which the slides 140 have previously been loaded prior to scanning. As a result thereof, a user can receive back the slides 140 in the same order in which they had been provided to the storage device 118.

As already indicated above, the exemplary slide imaging apparatus 110 as illustrated in FIG. 1 comprises the first imaging device 126 and the second imaging device 128, wherein each of the imaging devices 126, 128 is configured to generate an image 162 of a sample mounted on the slide 140. For this purpose, each of the imaging devices 126, 128 may, preferably, be selected from a 2D camera or a line scan detector. However, further kinds of imaging devices may also be feasible.

In a particular embodiment, at least one of the first imaging device 126 and the second imaging device 128 may comprise at least one indicator, e.g. in form of one or more LEDs 164, which are configured to indicate an operational status of the first imaging device 126 or the second imaging device 128, respectively. In this particular embodiment, the slide imaging apparatus 110 may, as depicted in FIG. 1, further comprise at least one vision sensor 166 which is configured to detect an operational status of at least one of the first imaging device 126 and the second imaging device 128 using an indication as provided by the indicator, e.g. by the one or more LEDs 164. For this purpose, the vision sensor 166 may comprise an optical recording device 168 as schematically depicted in FIG. 1. In a further embodiment (not depicted here), the slide imaging apparatus 110 may comprise at least two individual vision sensors 166, wherein each individual vision sensor 166 may comprise an individual optical recording device 168, wherein each individual optical recording device 168 may be assigned to detect the operational status of an individual imaging device 126, 128. However, further embodiments are still feasible.

In this manner, the slide imaging apparatus 110 may have independent access to the operational status of the first imaging device 126 or the second imaging device 128, respectively, without being required to get this piece of information from the first imaging device 126 and the second imaging device 128 in a direct fashion. However, a direct communication between the first imaging device 126 or the second imaging device 128, on one hand, and an operating system 170, on the other hand, for providing the operational status of the first imaging device 126 and the second imaging device 128 may also be feasible.

As indicated above, the slide imaging apparatus 110 may comprise an operating system 170 which can be configured to control the operation of one or more of the supply device 120, the first imaging device 126 and the second imaging device 128.

Herein, the operating system 170 may, preferably, comprise a processing device such as computer 172, a human-machine-interface such as input device 174 configured to input instructions to the computer 170, wherein the input device 174 may comprise a keyboard 176, and at least one display device 178. Further, the slide imaging apparatus 110 may comprise at least one monitor 180, which may preferably be mounted to a pivotable holder (not depicted here) in order to facilitate viewing the images 162 of the samples mounted on the slide 140 after being scanned by the first imaging device 126 or by the second imaging device 128 by a user from various positions.

Accordingly, the robotic arm 154 as comprised by the supply device 120 has a protrusion 182 which is arranged at the robotic arm 154. The protrusion 182 can be mounted to or formed at the robotic arm 154 in any conceivable fashion. The robotic arm may comprise the gripping device 158 which is configured to grip the slide holder 142, wherein the slide holder 142 is configured to hold the plurality of slides 140 as depicted there, wherein the protrusion 182 is arranged at the gripping device 158. However, further arrangements of the protrusion 182 at the supply device 120 are feasible. The protrusion 182 as comprised by the supply device 120, specifically by the gripping device 158, is configured to press the operating button 160 of the imaging device 126, 128. For this purpose, the protrusion 182 may be lance-shaped or finger-shaped. The operating button 160 may be or comprise an eject button, wherein the imaging device 126, 128 may be configured to eject a slide tray (not depicted here) when the eject button is pressed. Herein, the slide tray may be configured to hold the slides 140 or the slide holder 142, respectively, during the scanning of the at least one slide 140.

The gripping device 158 may comprise a first gripping part and a second gripping part, not visible in FIG. 1. The first gripping part and the second gripping part may be moveable relative to one another, e.g. in a linear fashion relative to one another. Further, the first gripping part and the second gripping part may have surfaces facing one another, wherein the surfaces may be substantially plane, thus, being adopted to adjacent surfaces of the slide 140 or the slide holder 142, respectively. In this fashion, the gripping device 158 may be capable of transferring the slide 140 or the slide holder 142 to the slide reception 156 of the imaging device 126, 128 in a tight fashion, thereby avoiding instability or a loss of the slide 140 or the slide holder 142, respectively, during transport.

A position of the elements of the slide imaging apparatus 110 may be one or more of variable, adaptable and adjustable within the frame 112. For example, the plate of the at least one imaging device 126, 128 and/or the plates 122, 124 may be adjustable in height. In this case, the position, e.g. translation and/or orientation, of the one or more imaging devices may change and with it the position of an operating button 160 and further elements of the imaging device 126, 128. Additionally or alternatively, the position of the slide reception 156 of the imaging device 126, 128 may be one or more of variable, adaptable and adjustable. However, knowledge about one or more of these positions, also denoted as target positions, may be essential for the supply device 120 for proper supply and/or introducing and/or removing the slides from the imaging device 126, 128. The target position may be a position of the imaging device 126, 128 and/or of an element of the imaging device 126, 128. The target position may be a position which is used for operating the supply device. The target position may be a position to which the supply device 120 is driven for performing a pre-defined action, e.g. one or more of gripping at least one slide 140, pressing a button, releasing at least one slide 140 and the like. The target position may be a position of at least one operating button 160 of the imaging device 126, 128 and/or of at least one slide reception 156 of the imaging device 126, 128. The relative positions of the elements of the imaging device 126, 128, e.g. of the operating button 160 and/or the slide reception 156, with respect to the imaging device 126, 128 may be pre-known. For example, the relative positions may be stored in the database of the operating system 170. Thus, in case the position of the imaging device 126, 128 in space, i.e. translation and orientation, is known, the position of the elements of the imaging device 126, 128 are known, too.

Usually, for programming of the supply device 120, the target position may be taught in to the supply device 120 by human. However, in case of the changes to the system, the teach-in procedure has to be repeated which is complex, time consuming and difficult. The present invention therefore proposes an autonomous teach-in of at least one target position.

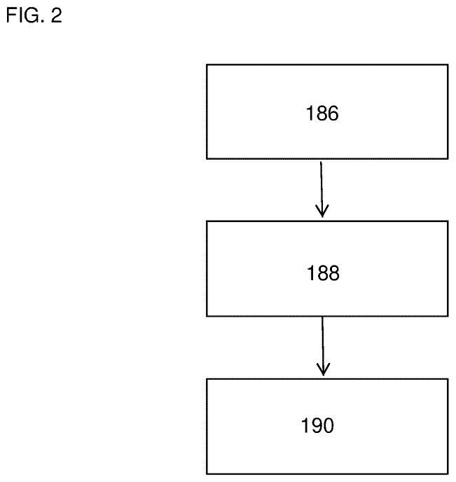

FIG. 2 shows an embodiment of for autonomous teach-in of at least one target position of the supply device 120 of the slide imaging apparatus 110. The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps
i) (denoted with reference number 186) providing at least six pre-defined positions by using the operating system 170;
ii) (denoted with reference number 188) driving the supply device 120 to the six pre-defined positions until colliding with the imaging device 126, 128 by using the operating system 170 and detecting collisions with the imaging device 126, 128;
iii) (denoted with reference number 190) evaluating the detected collisions by using the operating system 170, thereby determining the target position.

The teach-in may be or comprise a procedure for programming the supply device 120. The teach-in of the supply device 120 is performed without manual or human interaction with the robot during the teach-in. For this purpose, at least six pre-defined positions may be provided to the operating system 170 to which the supply device 120 is driven until colliding with the imaging device 126, 128. The coordinates, e.g. points, reached in this way may be stored by the operating system 170, e.g. in at least one database of the operating system 170.

A program sequence for driving the supply device 120 to the six pre-defined positions may comprise the supply device 120 autonomously moving to all the pre-defined positions.

The providing 186 may comprise retrieving and/or selecting the pre-defined positions. The providing 186 of the six pre-defined positions may comprises user input of the pre-defined positions via the human-machine-interface and/or receiving the six pre-defined positions from a database, e.g. of the operating system 170 and/or of an external database such as of a further computer or cloud. Additionally, further parameters may be entered by the user and/or may be retrieved from the database, e.g. for movement between the individual positions such as velocity and/or acceleration and/or accuracy. The pre-defined positions may be distributed, e.g. evenly, in space at an expected position of the imaging device 126, 128. For example, the pre-defined positions may be distributed on at least one expected plane of at least one side of the imaging device 126, 128 at which the target position is located.

The driving of the supply device 120 to each of the six pre-defined positions may comprise moving the robotic arm 154 from an initial position along a path. The path may be predefined, e.g. pre-programmed. The operating system 170 may drive the supply device 120 as long on the path until a collision with the imaging device 126, 128 is detected. In step ii) 188, the supply device 120 may be successively driven respectively along a path from an initial position to the six pre-defined positions until colliding with the imaging device 126, 128. The supply device 120 is driven along the respective path until a collision with the imaging device 126, 128 is detected, also beyond the respective pre-defined position. The operating system 170 may be configured for limiting the driving of the supply device 120 along a path, e.g. considering a time limit. In case no collision is detected within a predefined time limit of driving along the path, the driving may be aborted and/or continued in a different direction. For example, in case no collision is detected within a predefined time limit an indication, e.g. a message and/or a request for user action, may be issued by the operating system 170 via the human-machine-interface.

The driving of the supply device 120 in step ii) 188 may be performed by driving from point-to-point (P2P) and/or by using a continuous path (CP). In case of P2P, the supply device 120 may be driven from position n to position n+1. The path between the points may be preprogrammed or may be calculated online, i.e. during teach-in, considering the detected points of collision. In case of CP, the supply device 120 may consider a predefined path between the six pre-defined positions.

In step ii) 188, the supply device 120 may be driven with a velocity such that collisions with the imaging device are deformation-free for the supply device and the imaging device. The collision may be or may comprise an interaction between the imaging device 126, 128 and the supply device 120, e.g. a contact and/or crash.

The detecting of the collisions with the imaging device 126, 128 may be performed by using at least one collision sensor (not shown here). The collision sensor may comprise one or more of at least one optical sensor, at least one tactile sensor. The tactile sensor may be a mechanical tactile sensor and/or an inductive tactile sensor and/or a capacitive tactile sensor. The collision sensor may be an element of the supply device, e.g. of the protrusion. Additionally or alternatively, the sensor may be an external sensor e.g. an imaging sensor of the slide imaging apparatus. The slide imaging apparatus 110 may comprise at least one wirebound and/or wireless connection between the sensor and the operating system 170 for exchanging data, e.g. sensor data for evaluation by the operating system 170, and/or commands, e.g. for controlling the sensor. The point in space at which the collision is detected may be denoted as collision location.

Step iii) 190 may comprises determining coordinates for each collision location i, e.g. 3D coordinates, with i from 1 to n, with n being the number of pre-defined positions. The evaluation of the detected collisions may comprise solving a linear equation system considering the coordinates of the determined collision locations thereby determining the target position. The target position may be defined by a six dimensional pose comprising translation in three perpendicular axes x, y, z and three orientation values rot (x), rot (y), rot (z), denoted below as rotx, roty, rotz. For example, the positions of the 6 collision locations may be (X1′, X2′, Y1′, Y2′, Z1′, Z2′) with each having six values, wherein X1′, Y1′, Z1′, X2′, Y2′, Z2′ define the initial position and X1, Y1, Z1, X2, Y2, Z2 define the detected collision location. The equation system may be defined as

$$x = ( X 1 \cdot x - X 2 \cdot x ) / 2 + X 2 \cdot x$$

$$y = ( Y 1 \cdot y - Y 2 \cdot y ) / 2 + Y 2 \cdot y$$

$$z = ( Z 1 \cdot z - Z 2 \cdot z ) / 2 + Z 2 \cdot z$$

$$rotx = a {tan}^{2} ( ( Y 2 \cdot y - Y 1 \cdot y ) , ( Y 2 \cdot x - Y 1 \cdot x ) )$$

$$roty = 0$$

$$rotz = a {tan}^{2} ( ( Z 2 \cdot z - Z 1 \cdot z ) , ( Z 2 \cdot x - Z 1 \cdot x ) )$$

Step iii) 190 may further comprise at least one coordinate transformation into Euler orientations. For example, the operating system 170 may use for controlling the supply device 120 Euler orientations q1, q2, q3, q4. For example, the following transformation may be performed:

x1_ := cos(rotz) * cos(roty);
x2_ := sin(rotz) * cos(roty);
x3_ := −sin(roty);
y1_ := cos(rotz) * sin(roty) * sin(rotx) − sin(rotz) * cos(rotx);
y2_ := sin(rotz) * sin(roty) * sin(rotx) + cos(rotz) * cos(rotx);
y3_ := cos(roty) * sin(rotx);
z1_ := cos(rotz) * sin(roty) * cos(rotx) + sin(rotz) * sin(rotx);
z2_ := sin(rotz) * sin(roty) * cos(rotx) − cos(rotz) * sin(rotx);
z3_ := cos(roty) * cos(rotx);
x1 := −z1_;
x2 := −z2_;
x3 := −z3_;
y1 := x1_;
y2 := x2_;
y3 := x3_;
z1 := −y1_;
z2 := −y2_;
z3 := −y3_;
IF y3−z2 >= 0 THEN
sigQ2 := 1;
ELSE
sigQ2 := −1;
ENDIF
IF z1−x3 >= 0 THEN
sigQ3 := 1;
ELSE
sigQ3 := −1;
ENDIF
IF x2−y1 >= 0 THEN
sigQ4 := 1;
ELSE
sigQ4 := −1;
ENDIF
q1 := sqrt(x1+y2+z3+1) / 2;
q2 := sigQ2 * sqrt(x1−y2−z3+1) / 2;
q3 := sigQ3 * sqrt(y2−x1−z3+1) / 2;
q4 := sigQ4 * sqrt(z3−x1−y2+1) / 2;

After performing step iii) 190, the operating system 170 may have knowledge about the target position with its degrees of freedom. The method may allow that the teach-in can be performed autonomously, in particular completely autonomously. Therefore, adjusting of the positions of the imaging device and implementing changes can be performed faster and with reduced complexity. For example, in case of a slide imaging apparatus 110 having two imaging devices 126, 128 at two different positions, during commissioning and/or after a service operation the position of one or both of the imaging devices 126, 128 relative to the supply device 120 may change. The operating system 170 may perform the method as described above and can autonomously calculate the target position for the operating button 160 and/or the slide reception 156 and teach-in the supply device 120.

### LIST OF REFERENCE NUMBERS

110 slide imaging apparatus
112 frame
114 wheel
116 table
118 storage device
120 supply device
122 first plate
124 second plate
126 first imaging device
128 second imaging device
130 housing
132 safety door
134 safety switch
136 emergency stop switch
138 emergency stop button
140 slide
142 slide holder
144 row
146 top row
148 bottom row
150 fast lane
152 designated slide
154 robotic arm
156 slide reception
158 gripping device
160 operating button
162 image
164 light emitting diode (LED),
166 vision sensor
168 optical recording device
170 operating system
172 computer
174 input device
176 keyboard
178 display
180 monitor
182 protrusion
186 Step i)
188 Step ii)
190 Step iii)

1. A method for autonomous teaching of at least one target position of a supply device of a slide imaging apparatus, wherein the slide imaging apparatus comprises at least one imaging device configured to generate an image of a sample mounted on a slide, wherein the target position is a position on the imaging device, wherein the slide imaging apparatus comprises at least one operating system configured for controlling operation of the supply device, wherein the method comprises the following steps:
i) providing at least six pre-defined positions by using the operating system;
ii) driving the supply device to the six pre-defined positions until colliding with the imaging device by using the operating system and detecting collisions with the imaging device;
iii) evaluating the detected collisions by using the operating system, thereby determining the target position.

2. The method according to claim 1, wherein the target position is a position of at least one operating button of the imaging device and/or of at least one slide reception of the imaging device.

3. The method according to claim 1, wherein in step ii) the supply device is successively driven respectively along a path from an initial position to the six pre-defined positions until colliding with the imaging device, and wherein the supply device is driven along the respective path until a collision with the imaging device is detected beyond the respective pre-defined position.

4. The method according to claim 1, wherein the detecting of the collisions with the imaging device are performed by using at least one collision sensor, and wherein the at least one collision sensor comprises one or more of an optical sensor or a tactile sensor.

5. The method according to claim 1, wherein step iii) comprises determining coordinates of a respective collision location, wherein the evaluation of the detected collisions comprises solving a linear equation system considering the coordinates of the determined collision locations and thereby determining the target position.

6. (canceled)

7. A slide imaging apparatus comprising:
at least one imaging device configured to generate an image of a sample mounted on a slide, wherein the imaging device comprises at least one operating button, and wherein the imaging device comprises at least one slide reception configured for receiving the slide for generating the image;
at least one supply device configured to supply slides to the slide reception of the imaging device, wherein the supply device is configured to press the operating button;
at least one collision sensor configured for detecting collisions between the supply device and the imaging device; and
at least one operating system configured for controlling operation of the supply device,
wherein the operating system is configured for driving the supply device to at least six pre-defined positions until colliding with the imaging device and detecting collisions with the imaging device by using the collisions sensor, and
wherein the operating system is configured for evaluating the detected collisions by using the operating system, and thereby determining the position of at least one of the operating button or the slide reception.

8. (canceled)

9. The slide imaging apparatus according to claim 7, wherein the operating button is or comprises an eject button, and wherein the imaging device is configured to eject a slide tray when the eject button is pressed.

10. The slide imaging apparatus according to claim 7, wherein the slide imaging apparatus comprises at least one first imaging device and at least one second imaging device, wherein each of the at least one first imaging device and the at least one second imaging device is configured to generate an image of a sample mounted on a slide, wherein the supply device is configured for selectively supplying the slides to the at least one first imaging device or to the at least one second imaging device.

11. The slide imaging apparatus according to claim 7, wherein the supply device comprises at least one robotic arm, wherein the supply device comprises a protrusion configured for pressing the operating button, wherein the protrusion is one of lance-shaped or finger-shaped, and wherein the protrusion is arranged at the robotic arm.

12. The slide imaging apparatus according to claim 7, wherein the slide imaging apparatus comprises at least one storage device loadable with a plurality of slides and configured for storing the slides, wherein the supply device is configured for supplying the slides from the storage device to the imaging device, and wherein the supply device is configured for conveying the slides from the imaging device to the storage device.

13. (canceled)

14. (canceled)

15. (canceled)

16. At least one non-transitory computer-readable storage medium comprising a plurality of instructions stored thereon that, in response to execution by at least one processor, causes a slide imaging apparatus to:
provide at least six pre-defined positions by using an operating system of the slide imaging apparatus;
drive a supply device of the slide imaging apparatus to the six pre-defined positions until colliding with an imaging device of the slide imaging apparatus by using the operating system and detecting collisions with the imaging device; and
evaluate the detected collisions by using the operating system, thereby determining a target position of the supply device.

17. The at least one non-transitory computer-readable storage medium according to claim 16, wherein the imaging device is configured to generate an image of a sample mounted on a slide.

18. The at least one non-transitory computer-readable storage medium according to claim 16, wherein the target position is a position of at least one operating button of the imaging device.

19. The at least one non-transitory computer-readable storage medium according to claim 16, wherein the target position is a position of at least one slide reception of the imaging device.

20. The at least one non-transitory computer-readable storage medium according to claim 16, wherein to drive the supply device comprises to successively drive respectively the supply device along a path from an initial position to the six pre-defined positions until colliding with the imaging device, wherein the supply device is driven along the respective path until a collision with the imaging device is detected beyond the respective pre-defined position.

21. The at least one non-transitory computer-readable storage medium according to claim 16, wherein detecting the collisions with the imaging device are performed by using at least one collision sensor.

22. The at least one non-transitory computer-readable storage medium according to claim 21, wherein the at least one collision sensor comprises at least one optical sensor.

23. The at least one non-transitory computer-readable storage medium according to claim 21, wherein the at least one collision sensor comprises at least one tactile sensor.

24. The at least one non-transitory computer-readable storage medium according to claim 16, wherein to evaluate the detected collisions comprises to determine coordinates of a respective collision location.

25. The at least one non-transitory computer-readable storage medium according to claim 24, wherein to evaluate the detected collisions comprises to solve a linear equation system considering the coordinates of the determined collision locations, thereby determining the target position.
